(19) United States
(12) Patent Application Publication
(10) Pub. No.: US 2010/0045440 A1
(43) Pub. Date: Feb. 25, 2010

(54) IMPLANTABLE DEVICE WITH REMOTE READOUT

(76) Inventors: Remco Henricus Wilhelmus Pijnenburg, Eindhoven (NL); Youri Victorovitch Ponomarev, Leuven (BE); Matthias Merz, Leuven (BE); Ronald Dekker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/447,678

(22) PCT Filed: Oct. 31, 2007
(86) PCT No.: PCT/IB07/54426

§ 371 Date: Apr. 29, 2009

(30) Foreign Application Priority Data
Nov. 3, 2006 (EP) 06123453.0

(51) Int. Cl. H04Q 5/22

(52) U.S. Cl. 340/10.1

(57) ABSTRACT

The invention relates to a remotely readable electronic device (10), particularly an implantable device, with an O associated reader (20). The device comprises a resonance circuit (12) that can selectively be set into one of at least three different resonance states, wherein this state can wirelessly be sensed by the remote reader. In a particular embodiment, the resonance circuit (12) comprises two capacitors (C₁, C₂) that can selectively be connected or disconnected to the resonance circuit (12). The reader (20) preferably scans a given frequency range to detect spectral absorption patterns that correspond to certain resonance states of the resonance circuit (12).

### FIELD OF THE INVENTION

The invention relates to a remotely readable electronic device, particularly an implantable device, to a reader for remotely reading such a device, and to a wirelessly communicating system comprising such a device and reader.

### BACKGROUND OF THE INVENTION

The U.S. 2004/0113790 A1 discloses an implantable sensor with an antenna for taking up radio frequency (RF) signals emitted by a sender outside the body. By connecting or disconnecting an additional capacitor to a reactance circuit that is coupled to the antenna, the impedance of said reactance circuit can selectively be changed to encode sensor data. These impedance changes can remotely be detected by a reader.

### SUMMARY OF THE INVENTION

Based on this situation it was an object of the present invention to provide means that allow a more versatile remote readout of an electronic device.

This objective is achieved by a remotely readable electronic device according to claim 1, by a reader according to claim 5, by a wirelessly communicating system according to claim 7, and by an implantable device according to claim 9. Preferred embodiments are disclosed the dependent claims.

The remotely readable electronic device according to the present invention may be used in any application where data, for example sensed measurement values, shall be wirelessly read out from a distance. The device comprises the following components:
a) A resonance circuit with a receiver for taking up radio frequency (RF) signals and with a switching system for selectively setting the resonance circuit to one of at least three given resonance states with different resonance frequencies.
b) A control unit for controlling the switching system according to a predetermined protocol of data encoding.

The described electronic device has the advantage that its resonance circuit can selectively assume three, preferably four or more different states with different resonance frequencies which can be detected from outside. Each state can therefore encode one value of an n-state logic (n≧3), and each readout step of the resonance circuit can transport a corresponding amount of information. In comparison to a reactance that can only be switched between two different meaningful states, this means a considerable increase of the rate of data transfer. If the resonance circuit encodes four different states, it is for example possible to transport two bit of information with each readout step, thus doubling the data flow with respect to the two-states case.

According to a preferred embodiment of the invention, the given resonance states of the resonance circuit comprise the state of an open resonance circuit, i.e. a state that does not show any resonance and does not absorb any energy from RF fields it is exposed to. By including the state of an open resonance circuit into the set of possible, meaningful values, a maximal amount of information can be encoded with minimal hardware effort.

In an optional embodiment of the electronic device, the resonance circuit comprises at least one capacitor that can selectively be connected or disconnected via a switch of the switching system. Preferably the resonance circuit comprises two such capacitors, which allows to encode three different states (no capacitor, only one capacitor, and both capacitors connected). If the two capacitors have different capacitance, this further allows to discriminate which of them is connected in the case that only one capacitor is connected, and thus to encode two bit of information. In the general case, the resonance circuit comprises n capacitors (n≧2), preferably with capacitances C1, . . . Cn that are uncorrelated in the sense that they are all different from each other and that there are no two different combinations of the Ci that sum up to the same value. Mathematically this can be expressed by the condition that the equation

$${\sum }_{i = 1}^{n} {a}_{i} \cdot Ci = 0$$

with aᵢ ∈ {−1; 0; 1} can only be fulfilled if aᵢ=0 for all i. A circuit with such a set of capacitors can encode 2ⁿ different states, which allows to transmit n bit in each readout step.

In another embodiment of the invention, the resonance circuit comprises at least one inductance (e.g. a coil), that can selectively be connected or disconnected via a switch of the switching system. Preferably, said inductance may serve simultaneously as the receiver that takes up RF signals.

The invention further relates to a reader for a remotely readable electronic device, particularly for a device as it was described above. The reader comprises a sender for emitting RF signals with a tunable frequency and a detector for discriminating at least three different spectral patterns in the energy absorption of emitted RF signals. The reader may be a compact unit as well as a distributed system; thus the sender may for example be located at a first location (preferably near the remotely readable electronic device), while the detector is located at a different location, wherein sender and detector may communicate by wire or wirelessly.

The described reader has the advantage that three different logical values can be encoded in the spectrum of energy absorption of the emitted RF signals. Thus each interrogation of an absorber, for example a remotely readable electronic device of the kind described above, can transport more than one bit of information.

The sender of the described reader may for example emit a broadband RF signal that yields a spectrum of energy absorption in which the desired spectral patterns can be found. In another embodiment, the sender comprises a scanning module for scanning repetitively a given frequency range, wherein the detector associates a spectral pattern to each scan. In this case, the sensor always emits a monochromatic signal, wherein the frequency of said signal is varied over the given frequency range. The detector observes at each instance the reaction to such a monochromatic signal and composes the observed reactions to a complete spectral image that can be examined for the occurrence of specific patterns.

The invention further relates to a wirelessly communicating system, comprising a remotely readable electronic device and reader of the kind described above.

The aforementioned system preferably comprises means for a synchronization between the control circuit of the remotely readable electronic device and the reader. The readable device may for example keep the resonance state of its resonance circuit constant for some clock cycle to allow the reader the determination of said state. In this case the reader should be synchronized with the beginning and the duration of the clock cycle. If the duration of the clock cycle is (at least approximately) fixed, the reader may for example synchronize an internal clock with each detected change of the state of the resonance circuits.

The invention further relates to an implantable device comprising a remotely readable electronic device of the kind described above. For an implantable device it is particularly important to communicate as much information as possible with minimal power consumption. This can be achieved with the proposed remotely readable electronic device as it can be interrogated passively while allowing a high data flow rate by using at least three different logical values for encoding information.

The implantable device preferably comprises a sensor for sensing some physiological parameter, particularly for sensing a pressure (e.g. the blood pressure), a chemical component (e.g. CO₂ or sugar), a pH value, a temperature, or an electrical signal (e.g. an electrocardiographic signal).

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 shows schematically an implantable device according to the present invention with an associated reader;

FIG. 2 illustrates the communication protocol of the system of FIG. 1.

### DETAILED DESCRIPTION OF THE EMBODIMENTS

The power requirements for medical implantable devices are increasingly dominated by the power needed for sending data from the implant towards a device outside the human (or animal) body. A RF-signal generated in a such an implantable device travels through the body and can be detected by an antenna outside the body. This needs a lot of power which cannot be reduced due to the attenuation inside the body.

It is therefore proposed here to use passive communication for sending data from the implant to the outside world. This can reduce the power consumption of the implant enormously and thus for example increase the battery lifetime of the implantable medical device.

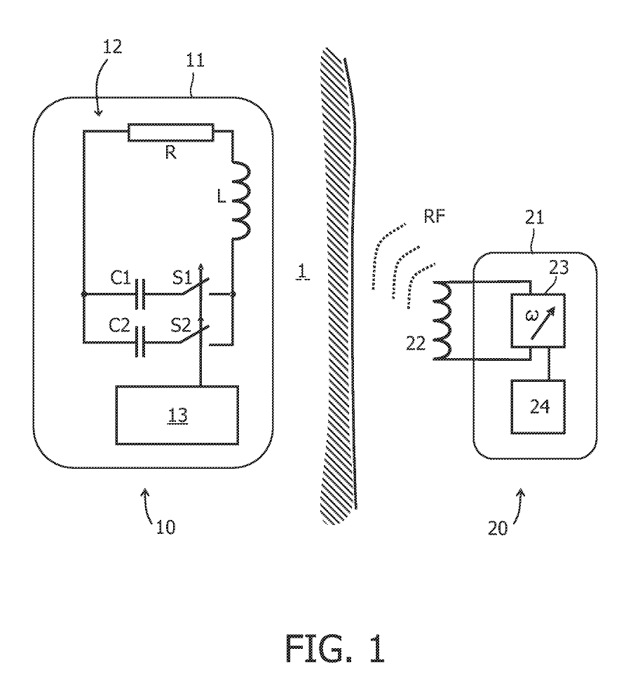

FIG. 1 shows schematically a remotely readable electronic device 10 according to the aforementioned approach that is implanted into the body 1 of a patient for sensing some parameter (e.g. blood pressure or the concentration of a chemical substance). The implantable device 10 comprises a resonance circuit 12 and an associated control unit 13 that are hermitically sealed by a physiologically acceptable casing 11. The resonance circuit 12 comprises in series
an ohmic resistor R,
a coil L serving as inductance and as antenna for taking-up radiofrequency signals RF, and
two capacitors C1 and C2 connected in parallel via a switching system with individual switches S1 and S2 for each capacitor, wherein the state (“open” or “closed”) of the switches S1 and S2 is individually controlled by the control unit 13.

The resonance frequency ω of the resonance circuit 12 depends as follows on the state of the switches S1 and S2 (note that the indices “0-0”, “1-0” etc. shall indicate binary numbers here):

S1 and S2 open:

$${ω}_{00} = \frac{1}{\sqrt{LC}} = ∞ ( no resonance )$$

S1 closed and S2 open:

$${ω}_{10} = \frac{1}{\sqrt{LC 1}}$$

S1 open and S2 closed:

$${ω}_{01} = \frac{1}{\sqrt{LC 2}}$$

S1 and S2 closed:

$${ω}_{11} = \frac{1}{\sqrt{L ( C 1 + C 2 )}}$$

Preferably the capacitances C1 and C2 are different (C1≠C2), because the resonance frequencies ω₁₀ and ω₀₁ are then different, too, and can therefore be discriminated.

The different resonance states of the resonance circuit 12, i.e. the different frequencies ωᵢⱼ, can be remotely detected by a reader 20 located outside the body 1. This may for example be achieved by using the “grid-dipping principle”: The term “grid-dipping” derives its name from a piece of test equipment called a “grid-dip meter”, used to tune the resonance frequency of LC-tanks. During such a procedure, an external tuning circuit generates an RF-signal which can be picked-up by the circuit under test. The grid current of the external tuning circuit will dip, when it oscillates at the resonance frequency of the circuit under test, due to the increased loading by the circuit under test. Thus the resonance frequency of an RF circuit can be measured wirelessly.

This principle can be applied to the passive communication from an implantable medical device towards an external device, wherein the implantable medical device 10 can contain an oscillator circuit 12 like that of FIG. 1. As the resonance frequency of this circuit changes according to the states of the switches S1 and S2, it is possible to detect said switching state from the outside. A 2-bit communication can therefore be established by creating a binary code for the state of the switches, for example:

S1 and S2 open: “0-0”
S1 closed and S2 open: “1-0”
S1 open and S2 closed: “0-1 ” (if C1≠C2)
S1 and S2 closed: “1-1”

Information can be sent from the implantable medical device 10 towards the outside world by changing the switches S1 and S2 as a function of time, and by sensing their state with the external reader 20.

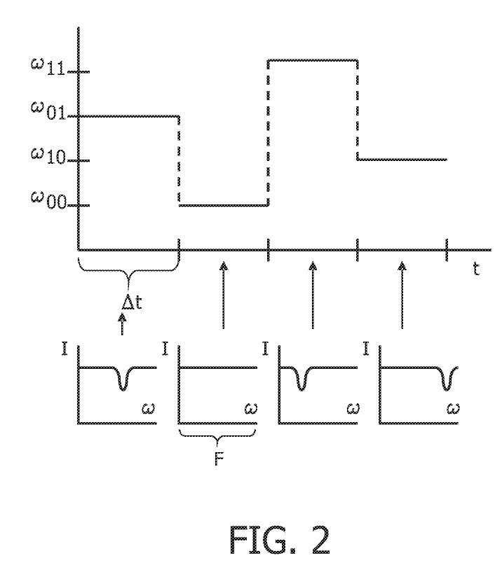

The reader 20 comprises an antenna 22 for the emission of RF signals and, in a casing 21, a scanning module 23 for sweeping the frequency co of these RF signals repetitively over a given frequency range F. This is illustrated in FIG. 2, which shows four exemplary sweeps of duration At that sense sequentially dips at the resonance frequencies ω₀₁, ω₀₀ (i.e. no dip), ω₁₁, and ω₁₀. A detector 24 of the reader 20 detects these frequencies and associates them to the binary codes “0-1”, “0-0”, “1-1”, and “1-0”.

While the resonance circuit of the described example comprised two capacitors C1, C2, the principle may of course also be realized with more capacitors, and it is also possible to use multiple inductors instead or additionally to capacitors for changing the resonance state of an oscillator. Moreover, the described principle of passive communication can not only be used for medical implantable devices, but also for other applications like autonomous sensors.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A remotely readable electronic device (10), comprising
a) a resonance circuit (12) with a receiver (L) for taking up RF signals and with a switching system (S1, S2) for selectively setting the resonance circuit to one of at least three given resonance states with different resonance frequencies (ω00, ω10, ω01, ω11);
b) a control unit (13) for controlling the switching system according to a predetermined protocol of data encoding.

2. The remotely readable electronic device (10) of claim 1, characterized in that the given resonance states comprise the state of an open resonance circuit (12).

3. The remotely readable electronic device (10) of claim 1, characterized in that the resonance circuit (12) comprises at least one capacitor (C1, C2), preferably two capacitors, that can selectively be connected or disconnected via a switch (S1, S2) of the switching system.

4. The remotely readable electronic device (10) of claim 1, characterized in that the resonance circuit (12) comprises at least one inductance, preferably two inductances, that can selectively be connected or disconnected via a switch of the switching system.

5. A reader (20) for a remotely readable electronic device (10), particularly a device (10) according to claim 1, comprising
a) a sender (22) for emitting RF signals with a tunable frequency,
b) a detector (24) for discriminating at least three different spectral patterns in the energy absorption of emitted RF signals.

6. The reader according to claim 5, characterized in that it comprises a scanning module (23) for scanning repetitively a given frequency range (F), wherein the detector (24) associates a spectral pattern to each scan.

7. A wirelessly communicating system, comprising a remotely readable electronic device (10), comprising
a) a resonance circuit (12) with a receiver (L) for taking up RF signals and with a switching system (S1, S2) for selectively setting the resonance circuit to one of at least three given resonance states with different resonance frequencies (ω00, ω10, ω01, ω11);
a control unit (13) for controlling the switching system according to a predetermined protocol of data encoding and a reader (20) according to claim 5.

8. The system according to claim 7, characterized in that it comprises means for a synchronization between the control unit (13) of the remotely readable electronic device (10) and the reader (20).

9. An implantable device, comprising a remotely readable electronic device (10) according to claim 1.

10. The implantable device according to claim 9, characterized in that it comprises a sensor for some physiological parameter, particularly for a pressure, a chemical component, a pH value, a temperature, or an electrical signal.
